(19) United States
(12) Patent Application Publication
(10) Pub. No.: US 2017/0251298 A1
(43) Pub. Date: Aug. 31, 2017

(54) OVERHEAD SPEAKER SYSTEM

(71) Applicants: DOLBY LABORATORIES LICENSING CORPORATION, San Francisco, CA (US); DOLBY INTERNATIONAL AB, Amsterdam Zuidoost (NL)

(72) Inventors: Brett G. CROCKETT, Brisbane, CA (US); Mark TUFFY, Sonoma, CA (US); James Alexander SHANNON, Royal Wootton Bassett (GB)

(73) Assignees: DOLBY LABORATORIES LICENSING CORPORATION, San Francisco, CA (US); DOLBY INTERNATIONAL AB, Amsterdam Zuidoost (NL)

(21) Appl. No.: 15/511,488

(22) PCT Filed: Sep. 16, 2015
(86) PCT No.: PCT/US2015/050503

§ 371 Date: Mar. 15, 2017

Related U.S. Application Data
(60) Provisional application No. 62/054,458, filed on Sep. 24, 2014.

(51) Int. Cl. H04R 1/34; H04R 1/28; H04R 27/00; G10K 11/28

(52) U.S. Cl. CPC H04R 1/345; G10K 11/28; H04R 1/288; H04R 27/00

(57) ABSTRACT

There is provided a sound system comprising: a first reflector arranged overhead and to reflect sound into a listening environment, a sound emitting device comprising a sound source and a second reflector, the sound source being configured to direct a sound beam with a first beam angle into the second reflector, the sound emitting device being any of a horn or parabolic loudspeaker. The second reflector is shaped to reflect the sound beam with a second beam angle towards the first reflector, and the first reflector is shaped such as it reflects the sound beam back to the listening environment with a third beam angle. The second beam angle is less than the first beam angle, and the third beam angle is greater than the second beam angle. There is further provided a sound system wherein three of more reflectors are used to reflect sound back down to the listening environment. Additionally, at least one sound absorbing device of a three dimensional shape is positioned in between the overhead reflectors.

### CROSS REFERENCE TO RELATED APPLICATIONS

This application claims priority to U.S. Provisional Patent Application No. 62/054,458, filed on Sep. 24, 2014, which is hereby incorporated by reference in its entirety.

### TECHNICAL FIELD

The disclosure herein generally relates to sound systems and methods for installation of such sound systems.

### BACKGROUND

In modern listening environments there has been a trend for an increasing number of speakers, which better can position sound. Increasing the number of speakers makes it possible to make the listening experience more as in reality. For example, hearing a helicopter flying by in a listening environment feels more as in real life when many speakers are used to position the sound.

In systems that are object based, specific objects can be positioned in a listening room with the help of many speakers. Some audio systems use up to 128 speakers, with up to 24 speakers positioned in the ceiling. Installing many speakers in the ceiling can be difficult and expensive since it for instance requires scaffolding and closing an auditorium down for a considerable time. There is thus a desire to have a system that is simpler and cheaper to install but that still enables high spatial granularity.

### BRIEF DESCRIPTION OF THE DRAWINGS

Example embodiments will now be described with reference to the accompanying drawings, on which:

FIG. 1 is a schematic illustration of a sound system arranged in a listening environment according to exemplary embodiments.

FIG. 2 is a schematic side view of a sound emitting device and a reflector according to exemplary embodiments.

FIG. 3a is a schematic bottom plan view of an array of a plurality of reflectors.

FIG. 3b is a schematic side view of a sound emitting device, a target reflector, and neighboring reflectors according to exemplary embodiments.

FIG. 4 is a schematic illustration of a sound system arranged in a listening environment according to exemplary embodiments.

FIG. 5 is a flowchart of a method for installing a sound system according to exemplary embodiments.

FIG. 6 is a flowchart of a method for installing a sound system according to exemplary embodiments.

All the figures are schematic and generally only show parts which are necessary in order to elucidate the disclosure, whereas other parts may be omitted or merely suggested. Unless otherwise indicated, like reference numerals refer to like parts in different figures.

### DETAILED DESCRIPTION

In view of the above it is thus an object to provide sound systems which are cheap and easy to install but that enable high spatial granularity. It is a further object to provide installation methods for such sound systems.

### I. Overview—Sound System with a First, Broadening, Reflector

According to a first aspect, there is provided a sound system and a method for installing the sound system.

According to exemplary embodiments there is provided a sound system comprising:

a first reflector in a listening environment, wherein the first reflector is arranged to reflect sound down into the listening environment,

a sound emitting device arranged in the listening environment below the first reflector, the sound emitting device comprising a sound source and a second reflector,

wherein the sound source is configured to direct a sound beam with a first beam angle into the second reflector,

wherein the second reflector is shaped to reflect the sound beam with a second beam angle towards the first reflector, and

wherein the first reflector is shaped such as it reflects the sound beam back to the listening environment with a third beam angle, wherein the second beam angle is less than the first beam angle and the third beam angle is greater than the second beam angle.

In the above system (similarly to that of the first aspect), each ceiling or overhead speaker in a traditional sound system (or at least some of them) is replaced by a sound emitting device and a first, broadening, reflector. The sound emitting device generates a sound by means of a sound source, and the generated sound is focused and directed, by means of a second, focusing, reflector, towards the first reflector. The first reflector in turn disperses the sound and reflects it down into the listening environment in order to mimic a ceiling mounted loudspeaker. The first reflector is mounted in the listening environment, typically in the ceiling of the listening environment, and the sound emitting device is mounted below the first reflector, typically on one of the side-walls of the listening environment. Thus, with this arrangement, there is no need to install speakers and supporting infrastructure in the ceiling of the listening environment. In contrast, the reflectors which typically may be made of lightweight material such as fiberglass or plastic, are easy to install, for example by replacing existing ceiling tiles. This is advantageous in that it reduces installation costs. Moreover, the proposed system is particularly suitable in certain listening environments, such as in live concert venues, where it is impractical or even undesirable to place large speaker systems over an audience.

In this context the beam angle of a sound beam may be defined as the angle between the two directions opposed to each other over the beam axis for which the sound intensity is half that of the maximum sound intensity.

According to exemplary embodiments, the first reflector is shaped such that the third beam angle is at least 45 degrees and preferably no less than 90 degrees. In this way the beam angle of the sound reflected by the first reflector will be similar to the beam angle of a ceiling mounted speaker, and the sound reflected by the first reflector will hence sound as if it was emitted by a ceiling mounted speaker.

The sound source may be a loudspeaker. Moreover, the second reflector may have a concave shape, such as being a directional horn, or a curved parabolic reflector selected such that a reflected beam angle from the parabolic reflector is under an angle of 16 degrees. With such a reflected beam angle one may avoid that too much sound is directed towards neighboring ceiling reflectors.

Generally, the role of the first reflector is to broaden the beam angle of the incident sound beam (i.e. to disperse the sound beam) and to reflect the sound beam down into the listening environment. For this purpose, the first reflector may be convex shaped. As will be further explained below with respect to the second aspect, a part of the first reflector may be convex shaped. Further, a part of the first reflector may be concave shaped. In this way different types and degrees of curvature may be combined to achieve the desired dispersion pattern in the listening environment.

To further improve the directivity of the sound beam emitted by the sound emitting device, and for the reasons further explained with respect to the second aspect below, at least one sound absorbing device may be positioned next to the broadening reflector. The sound absorbing device may have a three dimensional shape, such as a pyramidal shape, a cubical shape, a wedge shape, or a half-spherical shape.

According to exemplary embodiments, there is also provided a method of installing the sound system of the first aspect. The installation method comprises:

installing a first reflector in a listening environment, wherein the first reflector is arranged to reflect sound down into the listening environment,

installing a sound emitting device in the listening environment below the first reflector, the sound emitting device comprising a sound source and a second reflector,

configuring the sound source to direct a sound beam with a first beam angle into the second reflector,

wherein the second reflector is shaped to reflect the sound beam with a second beam angle towards the first reflector, and

wherein the first reflector is shaped such as it reflects the sound beam back to the listening environment with a third beam angle, wherein the second beam angle is less than the first beam angle and the third beam angle is greater than the second beam angle.

According to exemplary embodiments a calibration is performed to position the first reflector in focus with the at least one sound emitting device. Such a calibration may ensure that the sound emitting device is aligned with and pointing towards the first reflector. In more detail, the calibration may be performed with a laser device. For example, a laser pointer may be attached to the sound emitting device in order to guide the installation of the sound emitting device in relation to the first reflector.

In other respects, the installation method may have the same features and advantages as the sound system of the first aspect, for example with respect to the embodiments of the first and third beam angles, the sound source, the second reflector, the first reflector, and the sound absorbing devices.

### II. Overview—Sound System with at Least Two Reflectors

According to a second aspect, there is provided a sound system and a method for installing the sound system.

According to exemplary embodiments there is provided a sound system comprising: a first and a second reflector in a listening environment, wherein the first and the second reflector are arranged to reflect sound down into the listening environment, a sound emitting device arranged in the listening environment below the first and second reflector, wherein the sound emitting device is configured to direct a diverging sound beam having a virtual point of origin towards a center of the first reflector, wherein a virtual angle is defined between: a first virtual straight line joining the virtual point of origin of the sound beam to the center of the first reflector, a second virtual straight line joining the virtual point of origin of the sound beam to a point on the second reflector, wherein said point is the point at which the second reflector is nearest to the first reflector, the configuration of the sound emitting device being selected such that the sound beam has a beam angle which is no greater than twice the virtual angle.

By the sound beam having a beam angle which is not substantially greater than twice the virtual angle is generally meant that the beam angle may not exceed twice the virtual angle by any substantial amount. For example, the beam angle of the sound beam may at most exceed twice the virtual angle by a small amount which for instance may be equal to one or a few degrees, or even a fraction of one degree.

In the above system, each ceiling or overhead speaker in a traditional sound system (or at least some of them) is replaced by a sound emitting device and a reflector. The sound emitting device directs a sound beam towards the reflector, which in turn reflects sound down into the listening environment. The reflector is mounted in the listening environment, typically in the ceiling of the listening environment, and the sound emitting device is mounted below the reflector in the listening environment, typically on one of the side-walls of the listening environment. Thus, with this arrangement, there is no need to install speakers and supporting infrastructure in the ceiling of the listening environment. In contrast, the reflectors which typically may be made of lightweight material such as fiberglass or plastic, are easy to install, for example by replacing existing ceiling tiles. This is advantageous in that it reduces installation costs. Moreover, the proposed system is suitable in certain listening environments, such as in live concert venues, where it is impractical or even undesirable to place large speaker systems over an audience.

As mentioned above, some audio systems use up to 128 speakers, with up to 24 speakers positioned in the ceiling. In the proposed system, the ceiling speakers are replaced by reflectors. This implies that the reflectors may be arranged quite close to each other. For this reason, there is a risk that a sound beam intended for a target reflector also is reflected by a neighboring reflector, thereby giving rise to cross-talk between the reflectors. In order to reduce this risk, it is proposed to restrict the beam angle of the emitted sound beam to a maximum beam angle. The maximum beam angle corresponds to twice an angle defined between a line from a (virtual) point of origin of the sound source and the center of the target reflector, and a line from the (virtual) point of origin of the sound source and the closest point on the neighboring reflector as seen from the target reflector. In this way, the sound beam will at most brush against the neighboring reflector without being reflected by it to any great extent.

The beam angle as used in the second aspect may be defined analogously to the beam angle of the first aspect.

In some embodiments, the system comprises three of more reflectors including the first reflector and the second reflector. In such embodiments it may be the case that no other reflector is nearer to the first reflector than the second reflector is.

According to exemplary embodiments, the sound emitting device comprises a sound source and a beam former. The sound source may for example be a loudspeaker. The role of the beam former is to focus a sound beam emitted by the sound source to produce a sound beam having a beam angle being at most the maximum beam angle mentioned above, and to direct the sound beam towards a target reflector. The beam former may for example be a directional horn, or a curved parabolic reflector where the sound source is located in or close to the focal point of the parabolic reflector and pointed towards the parabolic reflector dish. For instance, the curved parabolic reflector may be selected such that the reflected beam angle from the parabolic reflector is under an angle of 16 degrees. With such a reflected beam angle one may avoid that too much sound is directed towards neighboring ceiling reflectors.

Apart from serving as an acoustic beam former, a parabolic reflector is advantageous in that it acts as an acoustic amplifier. In particular, a sound emitting device with a parabolic reflector only has a drop off of three dB every doubling of distance as compared to a normal loudspeaker which has a six dB drop off. As a result, the acoustic amplification properties of the parabolic reflectors allow a speaker with lower power output capability to be used, thereby further reducing the costs of the sound system compared to a traditional sound system with ceiling mounted speakers.

Generally, the shape of the reflecting elements may be designed to reflect the sound down into the listening environment and to create a desired dispersion pattern in the listening environment. The shape of the reflecting elements may for instance be concave, convex, flat or combinations thereof. For example, the first and the second reflector may be convex shaped so as to generate a diffuse or dispersed acoustic pattern, similar to that of a loudspeaker. In such embodiment, a narrow (focused) sound beam sent from the beam former would get dispersed. In contrast, with a reflector of concave shape, a narrow (focused) sound beam sent from the beam former would remain or get narrow.

According to exemplary embodiments, a part of each reflector of the first and the second reflector is convex shaped. According to exemplary embodiments a part of each reflector of the first and the second reflector is concave shaped. In this way different types and degrees of curvature may be combined to achieve the desired dispersion pattern in the listening environment.

To further improve the directivity of the sound beam emitted by the sound emitting device, and to further reduce the risk of cross-talk between the reflectors, sound absorbing devices may be positioned between the reflectors. In more detail, at least one sound absorbing device may be positioned in between the first and the second reflector. The at least one sound absorbing device may have a three-dimensional shape, including a pyramidal shape, a cubical shape, a wedge-shape, and a half-spherical shape.

Having sound absorbing devices between the reflectors may have further advantageous effects. Adding reflectors to the ceiling may cause an increase in general reverberation in the listening environment. Moreover, sound from other loudspeakers in the listening environment, such as screen speakers in a cinema theatre, may be reflected by the reflectors thereby decreasing intelligibility and definition. However, the sound absorbing devices may shield the reflectors from sound emitted by other loudspeakers, thereby preventing sound from being reflected undesirably by the reflectors. In particular wedge-shaped absorbers have been found to advantageously reduce the reflection of direct sound from other loudspeakers in the listening environment.

Also, a sound absorbing device could be placed under the sound emitting device in order to reduce the amount of direct sound reaching listeners from the sound emitting device.

According to exemplary embodiments, there is also provided a method of installing the sound system of the second aspect. The method comprises:

installing a first and a second reflector in a listening environment, wherein the first and the second reflector are arranged to reflect sound down into the listening environment,

installing a sound emitting device in the listening environment below the first and the second reflector,

configuring the sound emitting device to direct a diverging sound beam having a virtual point of origin towards a center of the first reflector,

wherein a virtual angle is defined between:

a first virtual straight line joining the virtual point of origin of the sound beam to the center of the first reflector,

a second virtual straight line joining the virtual point of origin of the sound beam to a point on the second reflector, wherein said point is the point at which the second reflector is nearest to the first reflector.

According to exemplary embodiments a calibration is performed to position the first reflector in focus with the sound emitting device. Such a calibration may ensure that the sound emitting device is pointing towards the correct reflector. In more detail, the calibration may be performed with a laser device. For example, a laser pointer may be attached to the sound emitting device in order to guide the installation of the sound emitting device with respect to direction.

In other respects, the installation method may have the same features and advantages as the sound system of the second aspect, for example with respect to the embodiments of the sound emitting device, the reflectors, and the sound absorbing devices.

### III. Example Embodiments

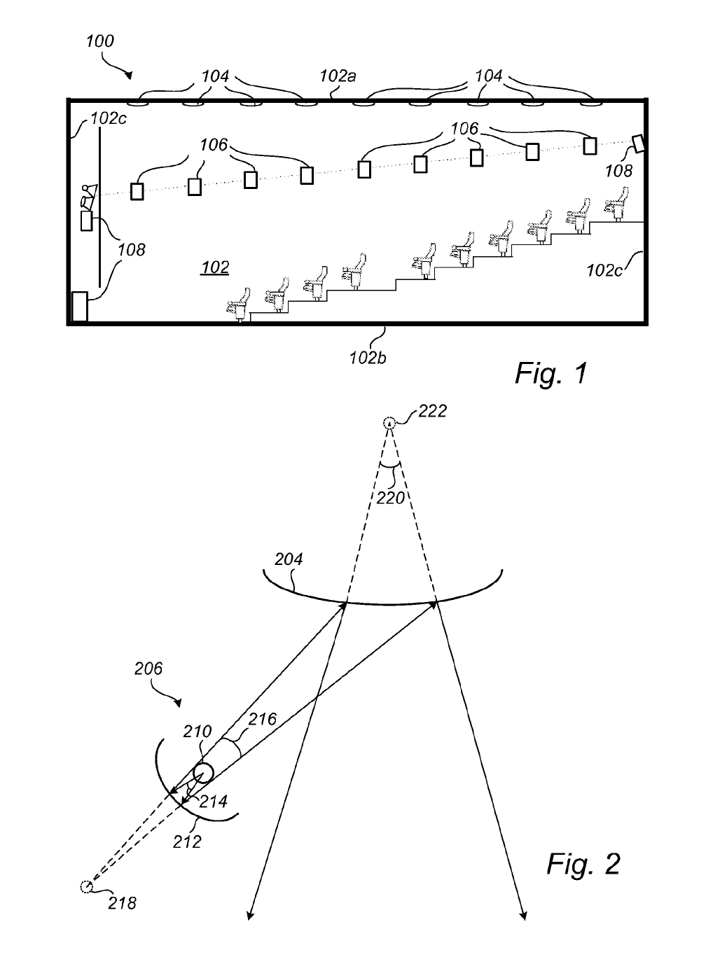

FIG. 1 illustrates a sound system 100 arranged in a listening environment 102. The sound system 100 comprises one or more reflectors 104, and one or more sound emitting devices 106 associated with the reflectors 104. The sound system 100 may further comprise additional loudspeakers 108.

The listening environment 102 may be a space restricted by an upper wall 102a (a ceiling), a lower wall 102b (a floor), and side walls 102c. The illustrated listening environment is a cinema theater, although other types of listening environments such as live concert venues, night clubs etc. are equally possible.

The reflectors 104 are arranged in the listening environment 102, such as in a first horizontal plane of the listening environment. The reflectors may typically be arranged in the upper wall 102a of the listening environment 102 or hanging from supports from the upper wall 102a of the listening environment 102. The reflectors 104 are made of an acoustically reflective material, and are arranged to reflect sound down into the listening environment 102, i.e. in the direction from the upper wall 102a towards the lower wall 102b. The reflectors 104 are preferably made from a light weight material such as plastic or fiberglass. The reflectors 104 could e.g. be in the form of specially shaped ceiling tiles or dishes. The shape of the reflectors 104 is typically designed to suit the desired dispersion pattern in the listening environment 104. For example, the reflectors 104 could have a convex parabolic shape, i.e. being bowed outwardly, in order to generate a diffuse acoustic pattern resembling that of a loudspeaker. In the case where a reflector 104 acts to disperse the sound, it is referred to herein as a broadening reflector. According to other examples, the reflectors 104 could have a concave parabolic shape to generate a focused acoustic beam. According to yet other examples, the reflectors 104 could have a flat shape. Alternatively, the reflectors 104 could have a combination of the different shapes discussed above.

The sound emitting devices 106 are each arranged below (in the direction towards the lower wall 102b) the first horizontal plane in which the reflectors 104 are arranged. Notably, as illustrated in FIG. 1, the sound emitting devices 106 need not be arranged in the same horizontal plane. The sound emitting devices 106 may be mounted on the side walls 102c of the listening environment 102 or on top of an existing surround loudspeaker. Alternatively, they may be mounted on a stand standing on the floor or similar arrangements. The sound emitting devices 106 are preferably mounted as high as possible in the listening environment in order to avoid that direct sounds emitted by the sound emitting devices 106 are heard by the audience.

Each sound emitting device 106 corresponds to one of the reflectors 104. For example, the leftmost sound emitting device 106 in FIG. 1 may correspond to the leftmost reflector 104 in FIG. 1, etc. More specifically, each sound emitting device 106 is configured to emit, focus and direct a (typically divergent) sound beam towards its corresponding reflector 104.

Here the sound emitting devices 106 are assumed to have a one to one correspondence with the reflectors 104. However, more generally this does not need to be the case. For example, two sound emitting devices 106 may correspond to the same reflector and vice versa.

A sound emitting device 106 may be comprised of a sound source, such as a loudspeaker, and a beam former (also referred to herein as focusing reflector). The beam former may be some sort of sound reflector (i.e. it is made of a sound-reflecting material), such as a directional horn or a curved parabolic reflector typically having a concave shape. The sound source is typically mounted in front of the beam former. For example, the sound source may be located in the focal point of a parabolic reflector and pointed towards the parabolic dish. However, in the case of e.g. a horn, the sound source is placed behind the beam former. The beam former hence acts to reflect, form, and direct the sound beam emitted by the sound source. In addition, it acts as an acoustic amplifier. Compared to a normal loudspeaker which has a drop off of six dB for every doubling of distance, a loudspeaker that is pointed into a parabolic reflector has a drop off of only 3 dB every doubling of distance, thereby providing a form of acoustic amplification. Due to the acoustic amplification properties of the beam former, the cost of the sound source may be reduced by allowing a sound source with lower power output capabilities to be used. Additionally, speaker costs could be reduced by having the overhead channel feeds to the sound sources to be crossed over at a higher cross-over frequency (e.g. 100-150 Hz), thereby allowing the use of sound sources that do not need to reproduce lower frequencies (thereby reducing costs) and using other loudspeakers in the listening environment 102, such as surround subwoofers, to replay any low frequency overhead audio energy.

As an alternative, the sound emitting device 106 may be a beam forming/steering speaker array. However, with such a solution the sound amplification effect discussed above is not achieved.

A reflector 104 and its corresponding sound emitting device 106 serve to replace a conventional ceiling mounted loudspeaker. For that reason, the reflectors 104 are typically mounted in the same positions as the ceiling mounted loudspeakers would be.

FIG. 2 illustrates a sound emitting device 206 and a corresponding reflector 204, sometimes referred to herein as a broadening reflector, in more detail. The sound emitting device 206 comprises a sound source 210 and a beam former 212, sometimes referred to herein as a focusing reflector. The illustrated beam former 212 is a parabolic dish having a concave shape. The sound source 210 is located close to the focal point of the beam former 212, and points towards the beam former 212.

When in use, the sound source 210 directs a sound beam with a first beam angle 214 into the beam former 212. The beam former will, due to its shape, reflect the sound beam with a second beam angle 216 towards the reflector 204. The sound beam reflected from the beam former 212 will sound as if it originates from a point 218 behind the beam former 212, i.e. the point 218 may be thought of as virtual point of origin of the reflected sound beam. The shape of the beam former 212 is such that it serves to focus the sound beam emitted by the sound source 210, meaning that the second beam angle 216 is less than the first beam angle 214.

The focusing property of the beam former 212 is important since it allows the sound emitting device 206 to direct the reflected sound beams with high precision towards the corresponding reflector 204. This is particularly important in applications where several reflectors 204 are mounted close together, as one wants to avoid the situation where the reflected sound beams hit several reflectors, thereby causing cross-talk.

The sound beam reflected from the beam former 212 is then reflected with a third beam angle 220 by the reflector 204. The illustrated reflector 204 has a convex shape causing the sound beam to be broadened, meaning that the third beam angle 220 is larger than the second beam angle 216. In some embodiments, the shapes of the focusing reflector 212 and the broadening reflector 204 are chosen such that the first beam angle 214 is approximately the same as the third beam angle 220. The sound beam reflected from the reflector 204 will sound as if it originates from a point 222 behind the reflector 204, i.e. the point 222 may be thought of as a virtual point of origin of the sound beam reflected by the reflector 204.

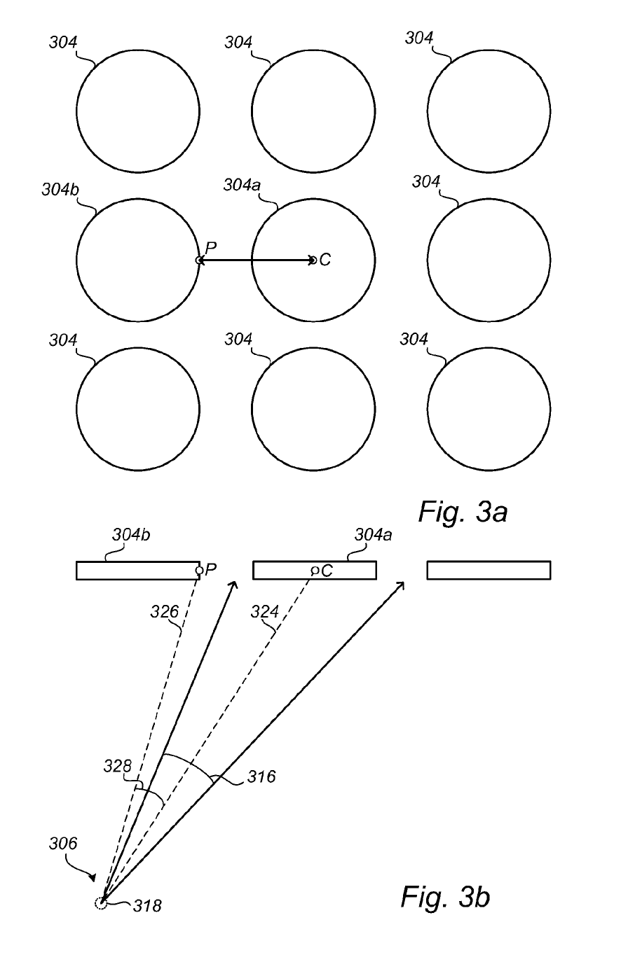

FIG. 3a illustrates a plan view of a plurality of reflectors 304, e.g. corresponding to reflectors 104 of FIG. 1, and FIG. 3b illustrates a side view of the plurality of reflectors 304. In particular, a first reflector 304a, and a second, neighboring, reflector 304b are shown. The neighboring reflector 304b may be the reflector among the plurality of reflectors 304 which is closest to the target reflector 304a.

FIG. 3b further shows a sound emitting device 306 having a virtual point of origin 318 (as explained with respect to FIG. 2). The sound emitting device 306 corresponds to the first reflector 304a.

A first (virtual, i.e. which is not visible in reality) straight line 324 may be defined between the virtual point of origin 318 of the sound emitting device 306 and a center C, such as a geometrically defined center or a center of gravity, of the first reflector 304a. Similarly, a second (virtual) straight line 326 may be defined between the virtual point of origin 318 of the sound emitting device 306 and a point P on the second reflector 304b. The point P is the point at which the second reflector 304b is nearest to the first reflector 304a. A virtual angle 328 is formed between the first straight line 324 and the second straight line 326.

As discussed with respect to FIGS. 1 and 2, the sound emitting device 306 directs a sound beam with a beam angle 316 towards the center C of the target reflector 304b. Due to the geometry, the sound beam emitted by the sound emitting device 306, will not be incident on the second reflector 304b as long as half the beam angle 316 is not greater than the virtual angle 328. (Differently stated, the beam angle 316 should not be greater than twice the virtual angle 328). In this way, cross-talk between the reflectors 304a and 304b can be avoided to a great extent.

As illustrated with respect to FIGS. 3a and 3b, there may be a plurality of reflectors 304 which are neighboring to the first reflector 304a. In order to avoid cross-talk between the first reflector 304a and any of its neighboring reflectors, a virtual angle may be defined in the above described manner with respect to each of the neighboring reflectors. The beam angle 316 should then be set such that it is not greater than twice the smallest one of the virtual angles defined with respect to the neighboring reflectors.

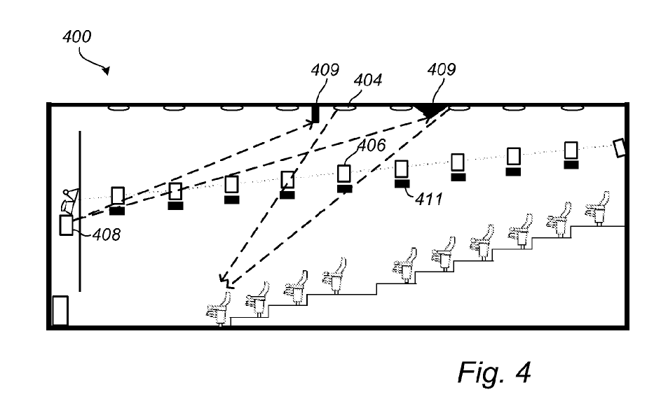

FIG. 4 illustrates a sound system 400. The sound system 400 is similar to that of FIG. 1 in that it comprises reflectors 404, sound emitting devices 406, and additional loudspeakers 408. Additionally, the sound system 400 comprises at least one sound absorbing device 409, 411.

The sound absorbing devices 409 are made from a sound absorbing material, and are positioned in between the reflectors 404. In this way, cross-talk between the reflectors may be further reduced. In more detail, a sound absorbing device 409 located between a first reflector and a second reflector may absorb sound in order to prevent a sound beam intended for the first reflector 404 from reaching the second reflector 404.

The sound absorbing devices 409 may further prevent sound originating from the additional loudspeakers 408, such as screen speakers and other surround speakers in a theatre, from being reflected by the reflectors 404. In more detail, the sound absorbing devices 409 may protrude, and have a three-dimensional shape which allows absorption of the direct sound from the additional loudspeakers 408, while allowing the reflectors 404 to disperse the sound emitted by the sound emitting devices 406. For example, the sound absorbing devices 409 may have a wedge or pyramidal shape, a cubical shape, or a half-spherical shape. This is further illustrated in FIG. 4 which shows that the sound absorbing devices 409 absorbs the sound emitted by the front additional loudspeaker 408, while they allow the sound reflected by the reflectors 404 to be dispersed down into the listening environment.

In order to reduce the amount of direct sound reaching listeners from the sound emitting devices 406, sound absorbing devices 411 may be placed under the sound emitting devices 406.

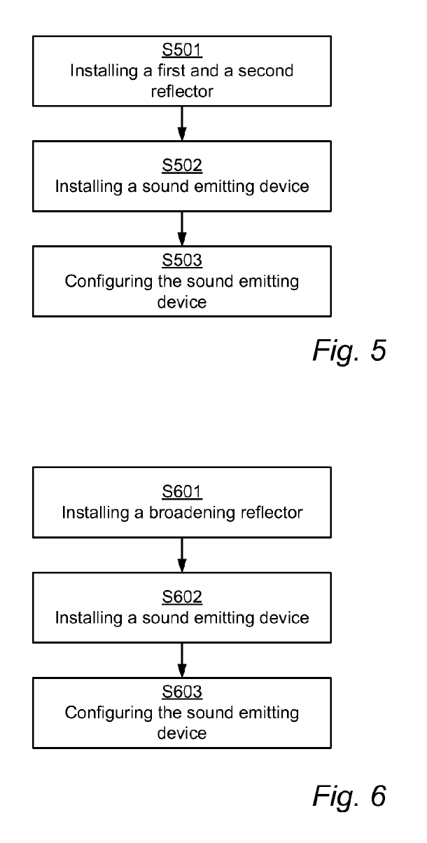

A first method of installing a sound system will now be described with reference to FIG. 1, FIGS. 3a-b and the flow chart of FIG. 5.

In step S501 a first and a second reflector 104, 304a, 304b, are installed in a first horizontal plane in a listening environment 102. For example the first and the second reflector 104, 304a, 304b may be installed in the ceiling, or mounted on supports hanging from the ceiling in the listening environment 102. The first and the second reflector 104, 304a, 304b may be directed such that they reflect sound down into the listening environment 102. For example, the reflectors 104, 304a, 304b may be directed in accordance with specifications for the ceiling loudspeakers which they replace.

In step S502, a sound emitting device 106, 306 is installed. For example, the sound emitting device 106, 306 may be installed on a side wall 102c of the listening environment 102 or on top of an existing surround speaker in the listening environment 102. In this way, overhead feeds may be played through the sound emitting device 106, 306 in order to direct the sound towards the reflector 104, 304, thereby enabling an efficient transmission of sound towards the reflector 104, 304a.

In step S503 the at least sound emitting device 106 is configured to direct a sound beam towards a center of the first reflector 104, 304a. In more detail, and explained with respect to FIG. 3b, the configuration of the sound emitting device 106 is selected such that the emitted sound beam has a beam angle 316 which is no greater than twice the virtual angle 328.

During installation of the sound emitting device 106, 306, one wants to make sure that the sound emitting device 106, 306, and in particular the beam former, is pointing at its corresponding reflector 104, 304a. For that purpose, a laser pointer may be attached to the sound emitting device 106, 306. When the laser pointer is found to point towards the center C of the target reflector 304a, the sound emitting device 306 and the target reflector 304a are correctly aligned.

A second method of installing a sound system will now be described with reference to FIG. 1, FIG. 2 and the flow chart of FIG. 6.

In step S601, a broadening reflector 104, 204 is installed in a first horizontal plane in the listening environment 102. For example, the broadening reflector 104, 204 may be installed on an upper wall 102a of the listening environment 102, e.g. by replacing an existing ceiling tile by a specially designed ceiling tile comprising the broadening reflector 104. The broadening reflector 104, 204 is arranged such that it reflects sound coming from below down into the listening environment 102. The shape of the broadening reflector 104, 204 is such that a sound beam reflected by the broadening reflector 104, 204 has a larger beam angle 220 than the beam angle 216 of the sound beam which is incident on the broadening reflector 104, 204. For example, this may be achieved by the broadening reflector 104, 204, or at least a part of it, having a convex shape.

In step S602 a sound emitting device 106, 206 is installed in the listening environment below the first horizontal plane. As exemplified with reference to FIG. 5, the at least one sound emitting device 106, 306 may be installed on a side wall 102c of the listening environment 102 or on top of an existing surround speaker in the listening environment 102.

In step S603, the sound source 210 of the sound emitting device 106, 206 is configured to direct a sound beam with a first beam angle 214 into the focusing reflector 214. The sound beam will be reflected by the focusing reflector 212 with a second beam angle 216. The second beam angle 216 should typically be less than the first beam angle 214. That is, the focusing reflector 212 focuses the sound beam in the direction of the broadening reflector 104, 204. The shape of the focusing reflector 212 influences the second beam angle 216 in relation to the first beam angle 214. For example, the focusing reflector 212 may have a concave shape. Moreover, the positioning of the sound source 210 in relation to the focusing reflector 212 also influences the relation between the first and second beam angles 212, 216. Thus, by varying the distance between the sound source 210 and the focusing reflector 214, the second beam angle 216 may be tuned.

Similar to the embodiment described with reference to FIG. 5, a laser pointer may be attached to the sound emitting device 106, 306 and used when directing the focusing reflector 212 in the direction of the broadening reflector 204. When the laser pointer is found to point towards the center of the target broadening reflector 204, the sound emitting device 206 and the target reflector 204 are correctly aligned.

### EQUIVALENTS, EXTENSIONS, ALTERNATIVES AND MISCELLANEOUS

Further embodiments of the present disclosure will become apparent to a person skilled in the art after studying the description above. Even though the present description and drawings disclose embodiments and examples, the disclosure is not restricted to these specific examples. Numerous modifications and variations can be made without departing from the scope of the present disclosure, which is defined by the accompanying claims. Any reference signs appearing in the claims are not to be understood as limiting their scope.

Additionally, variations to the disclosed embodiments can be understood and effected by the skilled person in practicing the disclosure, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

All the figures are schematic and generally only show parts which are necessary in order to elucidate the disclosure, whereas other parts may be omitted or merely suggested. Unless otherwise indicated, like reference numerals refer to like parts in different figures.

1. A sound system comprising:
a first reflector in a listening environment, wherein the first reflector is arranged to reflect sound down into the listening environment,
a sound emitting device arranged in the listening environment below the first reflector, the sound emitting device comprising a sound source and a second reflector,
wherein the sound source is configured to direct a sound beam with a first beam angle into the second reflector,
wherein the second reflector is shaped to reflect the sound beam with a second beam angle towards the first reflector, and
wherein the first reflector is shaped such as it reflects the sound beam back to the listening environment with a third beam angle, wherein the second beam angle is less than the first beam angle and the third beam angle is greater than the second beam angle.

2. The system of claim 1, wherein the first reflector is shaped such that the third beam angle is at least 45 degrees and preferably no less than 90 degrees.

3. The system of claim 1 or 2, wherein the sound source is a loudspeaker.

4. The system of any of claims 1-3, wherein the second reflector is a directional horn.

5. The system of any of claims 1-3, wherein the second reflector is a curved parabolic reflector selected such that a reflected beam angle from the parabolic reflector is under an angle of 16 degrees.

6. The system of any of claims 1-3, wherein the second reflector is concave shaped.

7. The system of any of claims 1-6, wherein the first reflector is convex shaped.

8. The system of any of claims 1-6, wherein a part of the first reflector is convex shaped.

9. The system of any of claims 1-6, wherein a part of the first reflector is concave shaped.

10. The system of any of claims 1-9, wherein at least one sound absorbing device is positioned next to the first reflector.

11. The system of claim 10, wherein the at least one sound absorbing device is having a three dimensional shape.

12. The system of claim 10, wherein the at least one sound absorbing device is having a pyramidal shape.

13. The system of claim 10, wherein the at least one sound absorbing device is having a cubical shape.

14. The system of claim 10, wherein the at least one sound absorbing device is having a half-spherical shape.

15. A method of installing a sound system comprising:
installing a first reflector in a listening environment, wherein the first reflector is arranged to reflect sound down into the listening environment,
installing a sound emitting device in the listening environment below the first reflector, the sound emitting device comprising a sound source and a second reflector,
configuring the sound source to direct a sound beam with a first beam angle into the second reflector,
wherein the second reflector is shaped to reflect the sound beam with a second beam angle towards the first reflector, and
wherein the first reflector is shaped such as it reflects the sound beam back to the listening environment with a third beam angle, wherein the second beam angle is less than the first beam angle and the third beam angle is greater than the second beam angle.

16. The method of claim 15, wherein the first reflector is shaped such that the third beam angle is at least 45 degrees and preferably no less than 90 degrees.

17. The method of claim 15 or 16, wherein the sound source is a loudspeaker.

18. The method of any of claims 15-17, wherein the second reflector is a directional horn.

19. The method of any of claims 15-17, wherein the second reflector is a curved parabolic reflector selected such that a reflected beam angle from the parabolic reflector is under an angle of 16 degrees.

20. The method of any of claims 15-17, wherein the second reflector is concave shaped.

21. The method of any of claims 15-20, wherein the first reflector is convex shaped.

22. The method of any of claims 15-20, wherein a part of the first reflector is convex shaped.

23. The method of any of claims 15-20, wherein a part of the first reflector is concave shaped.

24. The method of any of claims 15-23, wherein at least one sound absorbing device is positioned next to the first reflector.

25. The method of claim 24, wherein the at least one sound absorbing device is having a three dimensional shape.

26. The method of claim 24, wherein the at least one sound absorbing device is having a pyramidal shape.

27. The method of claim 24, wherein the at least one sound absorbing device is having a cubical shape.

28. The method of claim 24, wherein the at least one sound absorbing device is having a half-spherical shape.

29. The method of any of claims 15-28, wherein a calibration is performed to position the first reflector in focus with the sound emitting device.

30. The method of claim 29, wherein the calibration is performed with a laser device.

31. A sound system comprising:
a first and a second reflector in a listening environment, wherein the first and the second reflector are arranged to reflect sound down into the listening environment,
a sound emitting device arranged in the listening environment below the first and second reflector, wherein the sound emitting device is configured to direct a diverging sound beam having a virtual point of origin towards a center of the first reflector,
wherein a virtual angle is defined between:
a first virtual straight line joining the virtual point of origin of the sound beam to the center of the first reflector,
a second virtual straight line joining the virtual point of origin of the sound beam to a point on the second reflector, wherein said point is the point at which the second reflector is nearest to the first reflector,
the configuration of the sound emitting device being selected such that the sound beam has a beam angle which is not substantially greater than twice the virtual angle.

32. The system of claim 31, comprising three of more reflectors including the first reflector and the second reflector, wherein no other reflector is nearer to the first reflector than the second reflector is.

33. The system of claim 31 or 32, wherein the sound emitting device comprises a sound source and a beam former.

34. The system of claim 33, wherein the sound source is a loudspeaker.

35. The system of claim 33 or 34, wherein the beam former is a directional horn.

36. The system of claim 33 or 34, wherein the beam former is a curved parabolic reflector selected such that a reflected beam angle from the parabolic reflector is under an angle of 16 degrees.

37. The system of any of claims 31-36, wherein the first and the second reflector are convex shaped.

38. The system of any of claims 31-36, wherein a part of each of the first and the second reflector is convex shaped.

39. The system of any of claims 31-36, wherein a part of each of the first and the second reflector is concave shaped.

40. The system of any of claims 31-39, wherein at least one sound absorbing device is positioned in between the first and the second reflector.

41. The system of claim 40, wherein the at least one sound absorbing device is having a three dimensional shape.

42. The system of claim 40, wherein the at least one sound absorbing device is having a pyramidal shape.

43. The system of claim 40, wherein the at least one sound absorbing device is having a cubical shape.

44. The system of claim 40, wherein the at least one sound absorbing device is having a half-spherical shape.

45. A method of installing a sound system comprising:
installing a first and a second reflector in a listening environment, wherein the first and the second reflector are arranged to reflect sound down into the listening environment,
installing a sound emitting device in the listening environment below the first and the second reflector,
configuring the sound emitting device to direct a diverging sound beam having a virtual point of origin towards a center of the first reflector,
wherein a virtual angle is defined between:
a first virtual straight line joining the virtual point of origin of the sound beam to the center of the first reflector,
a second virtual straight line joining the virtual point of origin of the sound beam to a point on the second reflector, wherein said point is the point at which the second reflector is nearest to the first reflector,
selecting the configuration of the sound emitting device such that the sound beam has a beam angle which is not substantially greater than twice the virtual angle.

46. The method of claim 45, comprising installing three or more reflectors in the listening environment, including the first and the second reflector, wherein no other reflector is nearer to the first reflector than the second reflector is.

47. The method of claim 45 or 46, wherein the sound emitting device comprises of a sound source and a beam former.

48. The method of claim 47, wherein the sound source is a loudspeaker.

49. The method of claim 47 or 48, wherein the beam former is a directional horn.

50. The method of claim 47 or 48, wherein the beam former is a curved parabolic reflector selected such that a reflected beam angle of the parabolic reflector is under an angle of 16 degrees.

51. The method of any of claims 45-50, wherein the first and the second reflector are convex shaped.

52. The method of any of claims 45-50, wherein part of each of the first and the second reflector is convex shaped.

53. The method of any of claims 45-50, wherein part of each of the first and the second reflector is concave shaped.

54. The method of any of claims 45-53, wherein at least one sound absorbing device is positioned in between the first and the second reflector.

55. The method of claim 54, wherein the at least one sound absorbing device is having a three dimensional shape.

56. The method of claim 54, wherein the at least one sound absorbing device is having a pyramidal shape.

57. The method of claim 54, wherein the at least one sound absorbing device is having a cubical shape.

58. The method of claim 54, wherein the at least one sound absorbing device is having a half-spherical shape.

59. The method of any of claims 45-58, wherein a calibration is performed to position the first reflector in focus with the sound emitting device.

60. The method of claim 59, wherein the calibration is performed with a laser device.
